(19) United States
(12) Patent Application Publication
(10) Pub. No.: US 2016/0353131 A1
(43) Pub. Date: Dec. 1, 2016

(54) PVC METHOD USING VISUAL RECOGNITION CHARACTERISTICS

(71) Applicant: Korea Advanced Institute of Science and Technology, Daejeon (KR)

(72) Inventors: Munchurl KIM, Daejeon (KR); Jaeil KIM, Daejeon (KR)

(21) Appl. No.: 15/236,232

(22) Filed: Aug. 12, 2016

Related U.S. Application Data
(63) Continuation of application No. PCT/KR2015/001510, filed on Feb. 13, 2015.
(60) Provisional application No. 61/939,687, filed on Feb. 13, 2014.

(51) Int. Cl. H04N 19/61; H04N 19/182; H04N 19/154; H04N 19/176

(52) U.S. Cl. CPC H04N 19/61; H04N 19/176; H04N 19/182; H04N 19/154

(57) ABSTRACT

A PVC method using visual recognition characteristics includes generating a residual signal between an input block, which is included in at least one frame, and prediction data generated from an inter-frame prediction or intra-frame prediction. The PVC method further includes calculating a transform domain JND for the input block; shifting the calculated JND based on the size of the input block; and subtracting the shifted transform domain JND from a transform coefficient of the residual signal and quantizing the same.

### CROSS-REFERENCE TO RELATED APPLICATIONS

The present application is a continuation of International Patent Application No. PCT/KR2015/001510, filed on Feb. 13, 2015, which claims the benefit of priority to U.S. Provisional Application No. 61/939,687 filed on Feb. 13, 2014, which are incorporated herein by reference in their entirety.

### FIELD OF THE INVENTION

The present invention relates to a PVC (Perceptual Video Coding) method using visual perception characteristics, and more particularly to a method of performing encoding by eliminating signal components in a compression process based on the perception characteristics.

### BACKGROUND OF THE INVENTION

Recently, the High Efficiency Video Coding (HEVC) that is the video compression standard has been finalised by the Joint Collaborative Team on Video Coding (JCT-VC), a joint project of the ITU-T Video Coding Experts Group (VCEG) and the ISO/IEC Moving Picture Experts Group (MPEG). A HEVC encoder has a very high complexity compared to other video standards and compression performance which has reached a near saturation level in terms of the rate-distortion performance.

In this case, a rate-distortion optimization method is based on structural similarity for perceptual video coding. In this regard, as prior art documents, Korean Patent Application Publication No. 2014-0042845 (published on Apr. 7, 2014) discloses a rate-distortion optimization method using structural similarity (SSIM), and U.S. Patent Application Publication No. 2014-0169451 (published on Jun. 19, 2014) discloses a method for performing Perceptual Video Coding (PVC) using template matching.

However, even if the PVC is performed through template matching, in order to calculate a texture complexity Just Noticeable Difference (JND) model, the discrete cosine transform (DCT) is further performed, thereby causing an increase in complexity. Thus, it is practically impossible to apply the PVC to the HEVC encoder in consideration of memory and computing resources.

### SUMMARY OF THE INVENTION

An exemplary embodiment provides a PVC method using visual perception characteristics, capable of lowering the amount of calculations and resources used by calculating a texture complexity JND model using only the complexity of a pixel block without further performing the DCT to calculate the texture complexity JND model when performing the PVC using the JND, the PVC method being applicable to a real-time HEVC encoder. However, an exemplary embodiment is not restricted to the one set forth herein. The above and other exemplary embodiments will become more apparent to one of ordinary skill in the art to which an exemplary embodiment pertains by referencing the detailed description of an exemplary embodiment given below.

According to an exemplary embodiment, there is provided a PVC method comprising generating a residual signal between a input block included in at least one frame and prediction data generated from inter-frame prediction or intra-frame prediction, calculating a transform domain just noticeable difference (JND) for the input block, shifting the calculated JND based on a size of the input block, and performing quantization after subtracting a shifted transform domain JND from a transform coefficient of the residual signal.

According to an exemplary embodiment, since the JND is applied in accordance with the sensitivity which is perceived by a person, even though bits are reduced equally, it is possible to perform the compression with excellent visual quality. By further eliminating signal components that cannot be perceived by a person in the PVC, it is possible to increase the compression rate while maintaining the visual quality. In addition, by obtaining the texture complexity JND without separately calculating the DCT, it can be used in real-time encoding because the calculation amount and the complexity are low.

### BRIEF DESCRIPTION OF THE DRAWINGS

The exemplary embodiments provided herein may be best understood when read in conjunction with the accompanying drawings. It should be noted that various features depicted therein are not necessarily drawn to scale, for the sake of clarity and discussion. Wherever applicable and practical, like reference numerals refer to like elements.

FIG. 1 is a conceptual diagram illustrating a PVC method using visual perception characteristics according to an exemplary embodiment.

FIG. 2 is a block diagram illustrating a PVC apparatus using visual perception characteristics according to an exemplary embodiment.

FIG. 3 is a diagram for explaining a coding method according to a conventional technique.

FIG. 4 is a diagram for explaining the PVC method using visual perception characteristics according to an exemplary embodiment.

FIG. 5 is an operational flow diagram illustrating the PVC method using visual perception characteristics according to an exemplary embodiment.

### DETAILED DESCRIPTION OF THE EMBODIMENTS

In the following detailed description, for purposes of explanation but not limitation, representative embodiments disclosing specific details are set forth in order to facilitate a better understanding of the present teachings. However, it will be apparent to one having ordinary skill in the art having had the benefit of the present disclosure that other embodiments in accordance with the present teachings that depart from the specific details disclosed herein may still remain within the scope of the appended claims. Moreover, descriptions of well-known apparatuses and methods may be omitted so as not to obscure the description of the representative embodiments.

It is to be understood that the terminology used herein is for purposes of describing particular embodiments only, and is not intended to be limiting. Any defined terms are in addition to the technical and scientific meanings of the defined terms as commonly understood and accepted in the technical field of the present teachings.

As used in the specification and appended claims, the terms “a,” “an” and “the” include both singular and plural referents, unless the context clearly dictates otherwise. Thus, for example, “a device” may include a single or plural devices.

Although the terms “first,” “second,” etc. may be used herein to describe various elements, these elements should not be limited by these terms. These terms are used to distinguish one element from another. For example, a first element could be termed a second element, and, similarly, a second element could be termed a first element, without departing from the scope of the present teachings.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

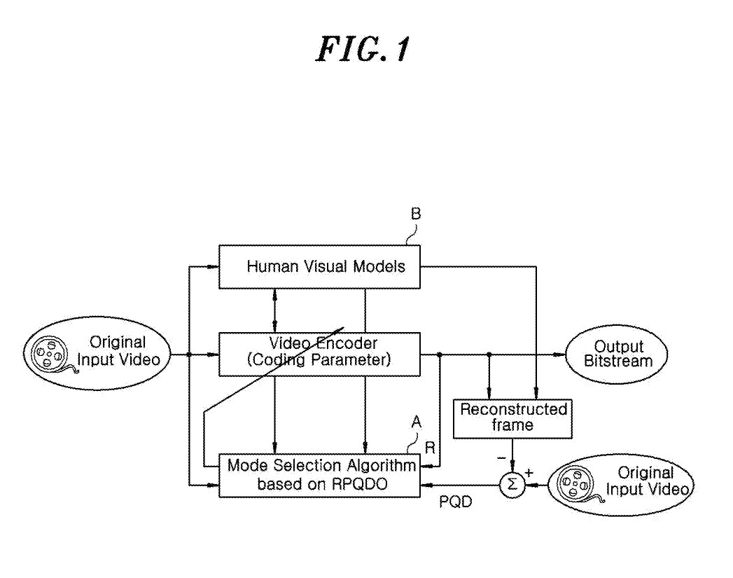

FIG. 1 is a conceptual diagram illustrating a PVC method using visual perception characteristics according to an exemplary embodiment. Referring to FIG. 1, the PVC method using visual perception characteristics of an exemplary embodiment is a Perceptual Video Coding (hereinafter, called “PVC”) method capable of improving the compression performance while minimizing subjective image quality impairment which is perceived by a person by eliminating signal components which cannot be perceived by a person in a compression process using the visual perception characteristics of a person, thereby outputting a bit stream of a higher compression ratio.

Referring to FIG. 1, the PVC method using visual perception characteristics according to an exemplary embodiment can achieve Output Bitrate Perception Quality Distortion Optimization (R-PQDO) using visual perception characteristics. In other words, a technique for measuring a minimum threshold value at which a person perceives the distortion of a video signal for each frequency or pixel and modeling the measured data can be applied. To this end, visual perception characteristics for the distortion of a video signal, i.e., a Just Noticeable Difference (JND) model, are used in a frequency domain and a pixel domain.

The JND may be one of visual perception models for obtaining the human visual residue. In this case, the JND may be defined as a difference between an original signal value and a value at which the person perceives a change or stimulation for the first time when a change or stimulation occurs in the video signal.

The HEVC may have a Transform Skip Mode (TSM) which is a mode in which only quantization is performed without performing transformation when encoding is carried out and a non Transform Skip Mode (nonTSM) which is a mode in which both transformation and quantization are performed when encoding is carried out.

First, the nonTSM will be described.

JND_{nonTSM} that is a JND model of the nonTSM may be defined by Eq. 1:

JND_{nonTSM}(i,j,μₚ,τ,mv)=αH_{csf}(i,j)MF_{LM}(μₚ)MF_{CM}(ω(i,j),τ)MF_{TM}(ω(i,j),mv) Eq. 1

where JND_{nonTSM}(i,j,μ,τ,mv) is a JND value to be used in the frequency domain, i.e., the nonTSM, and a is a constant and may be set to maximize the compression performance. Further, H_{csf}(i,j) means a perception characteristic model for modeling the human perception characteristics according to a frequency change, and MF_{LM}(μₚ) means a signal brightness characteristic model for modeling the signal brightness of a input block which is an block to be encoded. MF_{CM}(ω(i,j),mv) means a texture complexity characteristic model for modeling the texture complexity characteristics of the input block, and MF_{TM}(ω(i,j),mv) means a motion complexity characteristic model for modeling the motion complexity characteristics of the input block. Further, μₚ is defined as an average pixel value in the input block, τ is defined as the mean value of the complexity in the input block, and my is defined as a motion vector. In this case, the input block included in at least one frame is defined as the input data included in at least one frame which is inputted for perception coding.

In this case, ω(i,j) may be defined by Eq. 2:

$$ω ( i , j ) = \frac{1}{2 M} \sqrt{{( i \text{/} {θ}_{x} )}^{2} + {( j \text{/} {θ}_{y} )}^{2}} \qquad Eq . 2$$

where θₓ is a constant which is defined as a visual angle in a horizontal axis per pixel, and θ_{y} is a constant which is defined as a visual angle in a vertical axis per pixel. Further, M means the size of the input block and may have a value such as 4, 8, 16 and 32. Further, (i,j) means the position in the frequency domain and may have a value such as 0 to M-1.

Further, H_{csf}(i,j) that is a perception characteristic model may be defined by Eq. 3. In this case, the perception characteristic model may be a frequency perception characteristic model.

$${H}_{csf} ( i , j ) = \frac{1}{{φ}_{i} {φ}_{j}} \frac{exp ( cw ( i , j ) ) \text{/} ( a + bw ( i , j ) )}{r + ( 1 - r ) \cdot {cos}^{2} {Ψ}_{i , j}} \qquad Eq . 3$$

where each of a, b, c and r is a constant, φᵢ is defined as a normalized value of Discrete Cosine Transform (DCT) when the position of the frequency domain is i, φⱼ is defined as a normalized value of the DCT when the position of the frequency domain is j, ψ_{i,j} refers to a diagonal angle with respect to components of the DCT, and ω(i,j) refers to a spatial frequency when the position of the frequency domain is (i,j).

Further, MF_{LM}(μₚ) that is a signal brightness characteristic model may be defined by Eq. 4:

$${MF}_{LM} ( {μ}_{p} ) = \{ \begin{matrix}- {μ}_{p} ( A - 1 ) \text{/} B + A , & {μ}_{p} \leq B \\ 1 , & B < {μ}_{p} < C \\ ( {μ}_{p} - C ) ( D - 1 ) \text{/} ( {2}^{k} - 1 - C ) + 1 , & {μ}_{p} \geq C \end{matrix} \qquad Eq . 4$$

The signal brightness characteristic model is obtained by using the characteristics that a person is relatively sensitive to a signal change in the pixel having an intermediate brightness. In Eq. 4, k refers to a bit depth for representing a pixel, each of A, B, C and D is a constant, and μₚ which is an average pixel value in the input block is defined by Eq. 5:

$${μ}_{p} = ( 1 \text{/} {M}^{2} ) {\sum }_{y}^{M} {\sum }_{x}^{M} I ( x , y ) \qquad Eq . 5$$

where I(x,y) refers to a pixel value of the input block, and M refers to the size of the input block. The texture complexity characteristic model MF_{CM}(ω(i,j),mv) is obtained by using the characteristics that a person is insensitive to a change as the complexity of the input block increases. In this case, τ, which is calculated by edge determination, is defined by Eq. 6:

$$τ = ( 1 \text{/} {M}^{2} ) {\sum }_{y}^{M} {\sum }_{x}^{M} edge ( x , y ) \qquad Eq . 6$$

where edge(x,y) is set to 1 when being selected as an edge by edge determination, and is set to 0 when being unselected as an edge by edge determination.

Meanwhile, MF_{TM}(ω(i,j),mv) that is a motion complexity characteristic model is defined by Eq. 7:

$${MF}_{TM} ( ω ( i , j ) , mv ) = \{ \begin{matrix}1 , & {f}_{s} < 5 cpd and {f}_{t} < 10 Hz \\ {1.07}^{( {f}_{t} - 10 )} , & {f}_{s} < 5 cpd and {f}_{t} \geq 10 Hz \\ {1.07}^{{f}_{t}} , & {f}_{s} \geq 5 cpd \end{matrix} \qquad Eq . 7$$

The motion complexity characteristic model is obtained by using the characteristics that a person is insensitive to a change in the pixel if the motion of the input block is large. In Eq. 7, my refers to a motion vector, fₛ refers to a spatial frequency, and ft refers to a temporal frequency and may be determined by ω(i,j) and mv.

As described above, in the JND_{nonTSM}, the input block may be encoded in video coding by using four characteristic models in the frequency domain.

In this case, the PVC method using visual perception characteristics according to an exemplary embodiment may be implemented although all of the four characteristic models are not used. In other words, in a process of encoding the input block, the limitations of the computing resources for performing encoding and the complexity of calculation, such as Eq. 1, considering all of the four characteristic models may be taken into account. Therefore, JND_{nonTSM} such as Eq. 1 may be configured with a different version by selecting at least one of the four characteristic models without using all of the four characteristic models. In this case, when configuring a different version of the JND_{nonTSM}, it may be configured to include the perception characteristic model according to an exemplary embodiment. Thus, different versions of JND_{nonTSM} may be configured as represented in Eq. 8 to Eq. 10. In this case, in Eq. 8 to Eq. 10, different versions of JND_{nonTSM} are defined as JND_{nonTSM1}, JND_{nonTSM2}, and JND_{nonTSM3}, but it will be apparent that all of them refer to JND_{nonTSM}, which is a JND of the nonTSM.

JND_{nonTSM1}(i,j)=αH_{csf}(i,j) Eq. 8

where α is defined as a constant and may be set to maximize the compression performance. Eq. 8 represents the perception characteristics of an exemplary embodiment. In the PVC method using visual perception characteristics according to an exemplary embodiment, since the visual perception characteristics of a person are used, the perception characteristic model may be configured to be included as a necessary condition.

JND_{nonTSM2}(i,j,μₚ)=α_{csf}(i,j)MF_{LM}(μₚ) Eq. 9

Eq. 9 is obtained by configuring JND_{nonTSM} using the perception characteristic model and the signal brightness characteristic model. In this case, similarly to Eq. 8, a is defined as a constant and may be set to maximize the compression performance.

JND_{nonTSM3}(i,j,μₚ,τ)=αH_{csf}(i,j)MF_{LM}(μₚ)MF_{CM}(ω(i,j),τ) Eq. 10

Eq. 10 is obtained by configuring JND_{nonTSM} using the perception characteristic model, the signal brightness characteristic model and the texture complexity characteristic model. In this case, similarly to Eq. 9, a is defined as a constant and may be set to maximize the compression performance.

In addition to Eq. 8 to Eq. 10 as described above, other equations which can generate JND_{nonTSM} may be configured by combining the signal brightness characteristic model, the texture complexity characteristic model and the motion complexity characteristic model as sufficient conditions using the perception characteristic model as a necessary condition.

In this regard, in the case of an encoder consisting of hardware, a multiplication operation may not be performed easily due to the limitations of the computing resources. The PVC method using visual perception characteristics according to an exemplary embodiment may be configured in the form of a table. For example, in the cases of Eq. 8 and Eq. 9, it is possible to minimize the usage amount of the resources and hardware by generating in advance a JND value according to the size of the input block, storing the generated JND value in the form of a table, and using the previously stored data according to a change in the input variables.

Next, the TSM will be described. JND_{nonTSM} that is a JND model in the TSM will be described with reference to the following Eq. 11.

The TSM which is a mode in which only quantization is performed without performing transformation when encoding is carried out in the HEVC may use JND_{TSM}(μₚ), which is defined by Eq. 11:

$${JND}_{TSM} ( {μ}_{p} ) = \{ \begin{matrix}17 ( 1 - \sqrt{\frac{{μ}_{p}}{127}} ) + 3 & {μ}_{p} \leq 127 \\ \frac{3}{127} ( {μ}_{p} - 127 ) + 3 & {μ}_{p} > 127\end{matrix} \qquad Eq . 11$$

In the PVC method using visual perception characteristics according to an embodiment of the present invention, the frequency domain JND model and the pixel domain JND model can be applied in a hybrid manner depending on the mode in which encoding is performed through transformation and quantization and the mode in which encoding is performed through only quantization without performing transformation. However, it does not exclude the mode in which encoding is performed through transformation and quantization.

Meanwhile, a conventional texture complexity characteristic model of the frequency domain is configured as represented in Eq. 12, but the texture complexity characteristic model according to an exemplary embodiment is configured as represented in Eq. 13. In this case, the texture complexity characteristic model may be a texture complexity characteristic model of the frequency domain.

$${MF}_{CM 1} ( i , j , τ ) = \{ \begin{matrix}k , & for ( {i}^{2} + {j}^{2} ) \leq 16 \\ k \cdot min ( 4 , max ( 1 , {( \frac{C ( i , j , k )}{s \cdot {H}_{CSF} ( i , j ) \cdot {MF}_{LM} ( {μ}_{p} )} )}^{0.36} ) , & otherwise \end{matrix} \qquad Eq . 12$$

where C(i,j,k) is a result value obtained after performing the DCT of an original pixel block, and s is a constant value. In video encoding, encoding is performed on a residual signal, which is a difference between an original signal and a prediction signal after prediction, through transformation and quantization. In Eq. 12, the DCT should be performed on the original signal depending on all input blocks. However, in the case of HEVC, a bitrate-distortion value is calculated in order to determine a coding unit (CU) mode, a prediction unit (PU) mode, or a transform unit (TU) mode in a coding tree unit (CTU). When performing the DCT on the original signal block which is inputted each time, the complexity increases by more than 10 times of the total encoding time in a HEVC Test Model (HM) which is a reference software (reference SW) of the HEVC. Thus, the model of Eq. 12 is substantially unusable. Therefore, the PVC method using visual perception characteristics according to an exemplary embodiment is represented by Eq. 13:

$${MF}_{CM 2} ( ω ( i , j ) , τ ) = \{ \begin{matrix}( 1.5 τ - 0.16 ) w ( i , j ) + 0.74 {e}^{3 τ} , & ω ( i , j ) \leq 4.17 \\ ( - 0.5 τ + 0.05 ) ω ( i , j ) + 5 {e}^{1.7 τ} - 5 , & ω ( i , j ) > 4.17\end{matrix} \qquad Eq . 13$$

Eq. 13 can be calculated according to the position of the frequency domain by calculating the complexity of the input block using edge determination. Since there is a parameter that can be calculated in advance in a block unit, Eq. 13 can be calculated with a single multiplication and addition operation according to the position of the frequency, and Pearson Correlation Coefficient (PCC) and Root Mean Square Error (RMSE) exhibited high performance (93.95%) compared with human visual perception quality test results.

By applying the JND model through Eq. 1 to Eq. 13, the PVC method suitable for the HEVC will be described below.

Generally, PVC may be clarified into a standard-compliant scheme and a standard-incompliant scheme. In the case of a standard-incompliant PVC scheme, the performance improvement is high because the encoding efficiency is improved through additional computation in a decoder of the existing standard, but the availability is low because it is not compliant with the existing standard and decoding is impossible in a standard-compliant decoder which is commonly used. However, in the case of a standard-compliant PVC scheme, since the encoding efficiency is improved through the design of an encoder and it is designed so as not to influence a decoder, the availability is high because decoding is possible in a standard-compliant decoder which is commonly used.

Most of conventional standard-compliant coding schemes are disclosed in the previous video compression standard H.264/AVC. Since encoding is performed through a recursive operation and a multiplication operation, the complexity is very high, and the application thereof is almost impossible in a real-time or hardware encoder which requires low computational complexity. However, in the PVC method using visual perception characteristics according to an exemplary embodiment, a standard-compliant scheme can be realized only through simple calculation by applying the above-described JND model through Eq. 1 to Eq. 13. In this case, Eq. 14 is in accordance with quantization without applying the PVC, and Eq. 15 represents the PVC method using visual perception characteristics according to an exemplary embodiment. The PVC method using visual perception characteristics according to an exemplary embodiment is implemented such that a standard-compliant scheme can be realized only through simple calculation.

|l(n,i,j)|=([(|z(n,i,j)|)×f_{QP % 6}+offset])>>q bits Eq. 14

where l(n,i,j) denotes a coefficient obtained after quantization of the position (i,j) of the n-th block, and z(n,i,j) denotes a coefficient obtained before quantization of the position (i,j) of the n-th block. f_{QP % 6} is a multiplication factor value to quantize the transform coefficient of the (i,j) subband in HEVC. Offset is a rounding offset.

$$\vert {l}_{JND} ( n , i , j ) \vert = \{ \begin{matrix}( [ ( \vert z ( n , i , j ) \vert - {JND}^{′} ( n , i , j ) ) \times {f}_{QP \%6} + offset ] ) >> qbits , & \vert z ( n , i , j ) \vert {JND}^{′} ( n , i , j ) \\ 0 , & \vert z ( n , i , j ) \vert \leq {JND}^{′} ( n , i , j )\end{matrix} \qquad Eq . 15$$

l_{JMD}(n,i,j) denotes coefficient obtained by applying the PVC method after quantization of the position (i,j) of the n-th block. If the value |z(n,i,j)| is smaller than or equal to JND′(n,i,j), L_{JND}(n,i,j) is zero. f_{QP % 6} is a multiplication factor value to quantize the transform coefficient of the (i,j) subband in HEVC. Offset is a rounding offset. If the value |z(n,i,j)| is greater than JND′(n,i,j), quantization is performed after subtracting JND′(n,i,j) from the value |z(n,i,j)|. In this case, JND′(n,i,j) according to an exemplary embodiment is a scaled-up JND value and can be calculated by Eq. 16:

JND′(n,i,j)=JND(n,i,j)<<TransformShift Eq. 16

where Eq. 1 is substituted into JND(n,i,j) if the input block is in the nonTSM and Eq. 11 is substituted into JND(n,i,j) if the input block is in the TSM. In Eq. 16, since a transform kernel of the HEVC is configured to perform only an integer operation and the norm value varies depending on the size of the transform kernel, transformshift is set to 5 if the size of the input block is 4×4, 4 if the size of the input block is 8×8, 3 if the size of the input block is 16×16, and 2 if the size of the input block is 32×32 such that the JND value is set to the same level as the transform coefficient z(n,i,j) to calculate a final value of Eq. 16. In this case, as can be seen from Eq. 15, since it suffices to subtract the JND value according to the position of each residual signal, it is possible to achieve a low-complexity PVC method by applying the JND only through a subtraction operation.

In this case, the PVC method using visual perception characteristics performed by a processor according to an exemplary embodiment enables PVC by selecting only a portion of the input blocks having sizes of, e.g., 4×4 to 32×32, in consideration of the performance and resources and applying the JND value to the selected blocks. For example, the PVC may be applied to only blocks of 4×4 and 8×8 and the PVC may not be applied to the remaining blocks of 16×16 and 32×32. However, it will be apparent that it is not limited to the above-described embodiment, and whether to apply the PVC method to any combination of the input block sizes may be changed.

Hereinafter, a process of executing the PVC method using visual perception characteristics according to an exemplary embodiment will be described in comparison with a conventional technique.

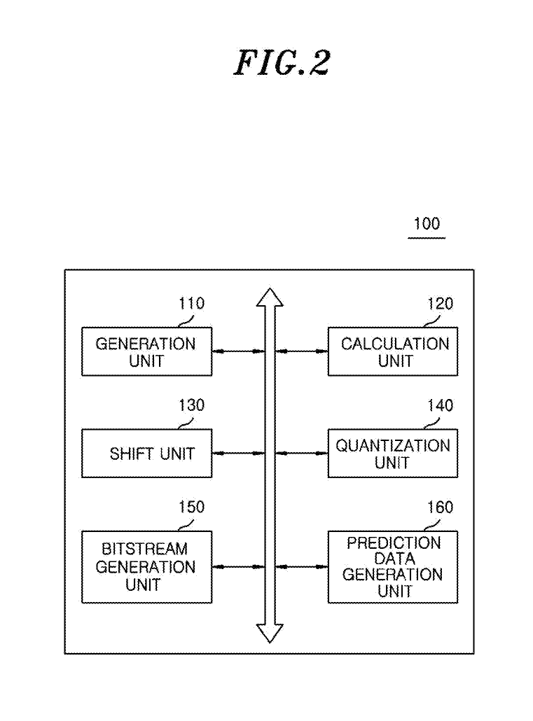

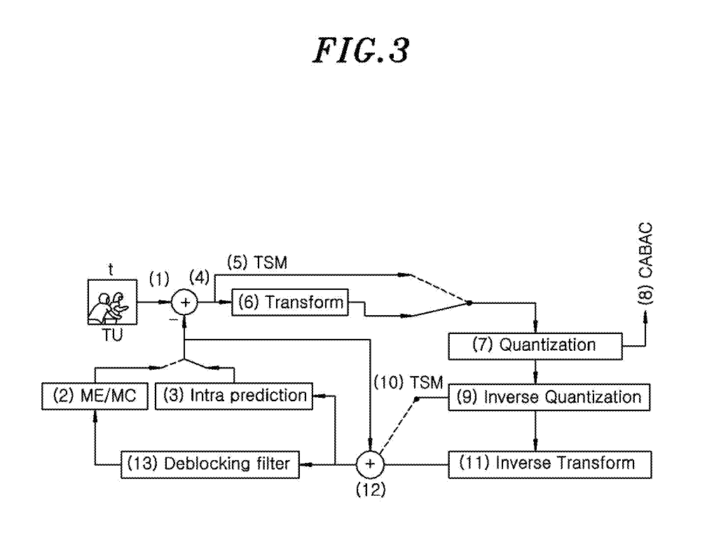

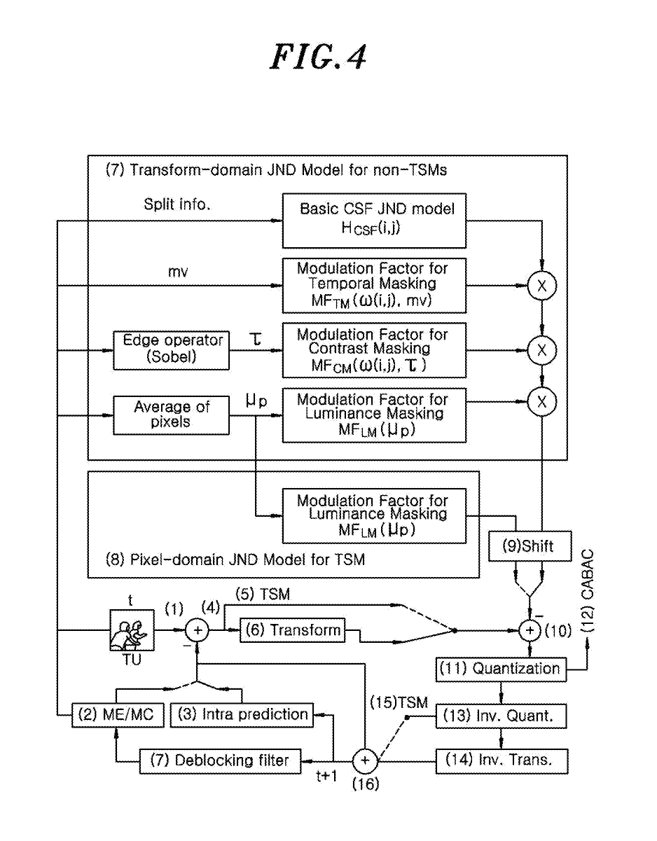

FIG. 2 is a block diagram illustrating a PVC apparatus using visual perception characteristics according to an exemplary embodiment. FIG. 3 is a diagram for explaining a coding method according to a conventional technique. FIG. 4 is a diagram for explaining the PVC method using visual perception characteristics according to an exemplary embodiment.

Referring to FIG. 2, a PVC apparatus 100 using visual perception characteristics having a processor according to an exemplary embodiment may include a generation unit 110, a calculation unit 120, a shift unit 130, a quantization unit 140, a bitstream generation unit 150 and a prediction data generation unit 160.

A hybrid example of the PVC method using visual perception characteristics according to an exemplary embodiment will be described with reference to FIG. 2. That is, both a case where the input block is in the TSM and a case where the input block is in the nonTSM will be described. However, it does not exclude a non-hybrid example where the input block is in the TSM or where the input block is in the nonTSM, and it will be apparent that each case can be executed.

The generation unit 110 may generate a residual signal between a input block included in at least one frame and prediction data generated from inter-frame prediction or intra-frame prediction. The inter-frame prediction may use motion estimation (ME) and motion compensation (MC). After the inter-frame prediction or intra-frame prediction, a case where the input block is in the TSM or a case where the input block is in the nonTSM may be selected.

The calculation unit 120 may calculate a pixel domain JND if the input block is in the TSM, and calculate a transform domain JND if the input block is in the nonTSM. If the input block is in the nonTSM, the calculation unit 120 may calculate the transform domain JND by using at least one model of the human perception characteristic model according to the frequency, the motion complexity characteristic model of the input block, the texture complexity characteristic model of the input block and the signal brightness characteristic model of the input block. In addition, if the input block is in the TSM, the calculation unit 120 may calculate the pixel domain JND by using a pixel characteristic model.

The shift unit 130, if the input block is in the TSM, may generate a shifted residual signal by performing transformshift on the residual signal, and shift the calculated JND based on the size of the input block. In FIGS. 3 and 4, a process of shifting the residual signal after being outputted when the input block is in the TSM mode has been omitted, but will be replaced by the detailed description of an exemplary embodiment. In this case, the shift unit 130 adjusts the calculated JND value by using transformshift according to the magnitude of the transform coefficient of the input block.

The quantization unit 140 may perform quantization after subtracting the shifted pixel domain JND from the shifted residual signal, if the input block is in the TSM, and subtracting the shifted transform domain JND from the transform coefficient of the residual signal, if the input block is in the nonTSM. When the input block is in the TSM, the shifted pixel domain JND is subtracted from the shifted residual signal if the shifted residual signal is greater than the shifted pixel domain JND, and zero is outputted if the shifted residual signal is equal to or smaller than the shifted pixel domain JND. When the input block is in the nonTSM, the shifted transform domain JND is subtracted from the transform coefficient of the residual signal if the transform coefficient is greater than the shifted transform domain JND, and zero is outputted if the transform coefficient is equal to or smaller than the shifted transform domain JND. The shifted residual signal may be a coefficient obtained before the quantization of the residual signal, and the transform coefficient may be a coefficient obtained before the quantization and after transformation of the residual signal.

The bitstream generation unit 150 may generate a bitstream through context-based adaptive binary arithmetic coding (CABAC).

The prediction data generation unit 160 may perform inverse quantization and a shift operation if the input block is in the TSM, and perform inverse quantization and inverse transformation to the input block to obtain an inverse quantized and inverse transformed transform block if the input block is in the nonTSM. Further, the prediction data generation unit 160 may generate a transform prediction block based on the the transform block and the input block that is the transform block included in at least one frame. The transform prediction block may be used in the intra-frame prediction, and a result of deblocking filtering the transform prediction block may be used in the inter-frame prediction.

The generation unit 110, the calculation unit 120, the shift unit 130, the quantization unit 140, the bitstream generation unit 150 and the prediction data generation unit 160 may be implemented by using one or more micro-processor.

The above-described PVC method using visual perception characteristics according to an exemplary embodiment and a conventional PVC method will be described with reference to FIGS. 3 and 4.

In the conventional PVC method, referring to FIG. 3, the transformation and quantization are performed through (5), (7) and (8) in the TSM, and the transformation and quantization are performed through (6), (7) and (8) in the nonTSM. On the other hand, in the PVC method using visual perception characteristics according to an exemplary embodiment, referring to FIG. 4, a bitstream is generated through (5), (8), (9), (10), (11) and (12) in the TSM, and a bitstream is generated through (5), (7), (9), (10), (11) and (12) in the nonTSM. In other words, in the PVC method using visual perception characteristics according to an exemplary embodiment, since the JND model is selected separately for each of the nonTSM and the TSM and a calculation process is minimized in the JND model, the amount of resources required and the amount of calculation can be reduced significantly.

Meanwhile, in the PVC method using visual perception characteristics according to an exemplary embodiment, in order to further improve the performance while preventing the rate-distortion value from increasing, Eq. 17 and Eq. 18 have been added as represented below, and a parameter F of FIG. 18 may be expressed by Eq. 19.

J₁=D+λ·R Eq. 17

where J₁ is defined as a value for determining an optimum mode in the latest video compression standard such as H.264/AVC and HEVC. Further, D is a distortion value which generally uses a Sum of Squared Error (SSE), R is a bit which is generated through the encoding, and λ is a Lagrangian multiplier, which is multiplied for the optimization of D and R, as a function of the quantization parameter (QP).

However, in FIG. 17, the SSE used as a distortion value does not always reflect the human perception characteristics. Further, since the QP is calculated to make the A larger as much as the bit is reduced through the JND, when applied to the PVC, the λ value becomes larger as the data of the block to which PVC has been applied is reduced. In addition to using modes for encoded blocks, prediction blocks and input blocks having various sizes, it supports SKIP modes for 8×8, 16×16, 32×32 and 64×64 blocks, which inevitably causes a limit in improving the performance due to an increase in the percentage of SKIP modes.

Therefore, the PVC method using visual perception characteristics according to an exemplary embodiment uses the following Eq. 18:

J₂=D·F+λ·R Eq. 18

where F is defined as a value which compensates for D, and may be calculated by Eq. 19:

$$F = \frac{{\sum }_{j = 0}^{M - 1} {\sum }_{i = 0}^{M - 1} \vert w ( n , i , j ) - {w}^{′} ( n , i , j ) \vert}{{\sum }_{j = 0}^{M - 1} {\sum }_{i = 0}^{M - 1} \vert w ( n , i , j ) - {w}_{JND}^{′} ( n , i , j ) \vert} \qquad Eq . 19$$

In the case of using the PVC method using visual perception characteristics according to an exemplary embodiment, while the percentage of the SKIP modes does not increase, the rate-distortion value is reduced, thereby further improving the performance. Also, it was confirmed from the experimental results on the encoding performance of the PVC method using visual perception characteristics according to an exemplary embodiment that the bit rate was reduced to a maximum of 49.1% and an average of 16.1% in the low delay (LD) condition, and reduced to a maximum of 37.28% and an average of 11.11% in the random access (RA) condition while subjective image quality does not largely change. Further, in the PVC method using visual perception characteristics according to an exemplary embodiment, the complexity of the encoder was increased only by 11.25% in the case of the LD and 22.78% in the case of the RA compared to the HM, and it can be seen that that this increase is very small compared to the conventional method in which the complexity was increased by 789.88% in the case of the LD and 812.85% in the case of the RA.

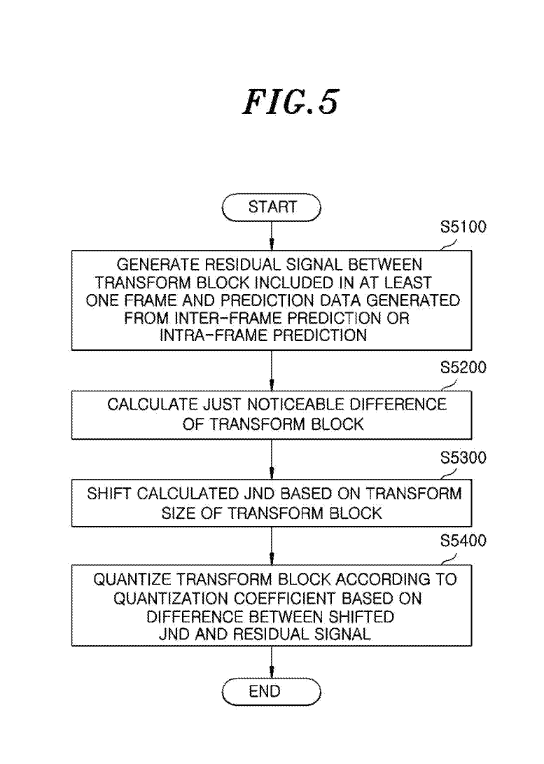

FIG. 5 is an operational flow diagram illustrating the PVC method using visual perception characteristics according to an exemplary embodiment.

Referring to FIG. 5, the PVC apparatus using visual perception characteristics generates a residual signal between a input block included in at least one frame and prediction data generated from inter-frame prediction or intra-frame prediction (S5100).

Then, the PVC apparatus using visual perception characteristics calculates a transform domain JND for the input block (S5200).

Further, the PVC apparatus using visual perception characteristics shifts the calculated JND based on the size of the input block (S5300).

Finally, the PVC apparatus using visual perception characteristics performs quantization after subtracting the shifted transform domain JND from the transform coefficient of the residual signal (S5400).

The PVC method using visual perception characteristics according to an exemplary embodiment as illustrated in FIG. 5 maybe performed by using one or more micro-processor.

The PVC method using visual perception characteristics according to an exemplary embodiment as illustrated in FIG. 5 may also be implemented in the form of a storage medium storing computer-executable instructions such as a program module or an application.

The combinations of respective sequences of a flow diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create means for performing functions described in the respective sequences of the sequence diagram. Since the computer program instructions, in order to implement functions in specific manner, may be stored in a memory useable or readable by a computer or a computer aiming for other programmable data processing apparatus, the instruction stored in the memory useable or readable by a computer may produce manufacturing items including an instruction means for performing functions described in the respective sequences of the sequence diagram. Since the computer program instructions may be loaded in a computer or other programmable data processing apparatus, instructions, a series of sequences of which is executed in a computer or other programmable data processing apparatus to create processes executed by a computer to operate a computer or other programmable data processing apparatus, may provide operations for executing functions described in the respective sequences of the flow diagram.

In view of this disclosure, it is to be noted that PVC method using visual perception characteristics can be implemented in a variety of elements and variant structures. Further, the various elements, structures and parameters are included for purposes of illustrative explanation only and not in any limiting sense. In view of this disclosure, those skilled in the art may be able to implement the present teachings in determining their own applications and needed elements and equipment to implement these applications, while remaining within the scope of the appended claims.

What is claimed is:

1. A perceptual video coding (PVC) method using visual perception characteristics, the method comprising:
generating a residual signal between an input block included in at least one frame and prediction data generated from inter-frame prediction or intra-frame prediction;
calculating a transform domain just-noticeable difference (JND) for the input block;
shifting the calculated transform domain JND based on a size of the input block; and
performing quantization to the input block based on a value obtained by subtracting the shifted transform domain JND from a transform coefficient of the residual signal.

2. The PVC method of claim 1, wherein said calculating a transform domain JND comprises calculating the transform domain JND by using a human perception characteristic model according to a frequency of a signal sensed by a user.

3. The PVC method of claim 2, wherein said calculating a transform domain JND comprises calculating the transform domain JND by using at least one model of a motion complexity characteristic model of the input block, a texture complexity characteristic model of the input block and a signal brightness characteristic model of the input block.

4. The PVC method of claim 3, wherein the texture complexity characteristic model of the input block is calculated based on a position of the input block in a frequency domain and complexity of the input block calculated by using edge determination.

5. The PVC method of claim 1, wherein the inter-frame prediction uses motion estimation (ME) and motion compensation (MC).

6. The PVC method of claim 1, wherein said shifting the calculated transform domain JND based on the size of the input block comprises setting a value of the calculated transform domain JND to the same level as a transform coefficient of the input block by using transformshift to be equal to a magnitude of an input signal.

7. The PVC method of claim 1, wherein said performing quantization comprises subtracting the shifted transform domain JND from the transform coefficient of the residual signal if the transform coefficient is greater than the shifted transform domain JND, and outputting zero if the transform coefficient is equal to or smaller than the shifted transform domain JND.

8. The PVC method of claim 1, wherein the transform coefficient is a coefficient obtained before the quantization and after transformation of the residual signal.

9. The PVC method of claim 1, further comprising, after said performing quantization, generating a bitstream through context-based adaptive binary arithmetic coding (CABAC).

10. The PVC method of claim 1, further comprising, after said performing quantization,
performing inverse quantization and inverse transformation to the input block to obtain an inverse quantized and inverse transformed transform block; and
generating a transform prediction block based on the transform block and the input block included in at least one frame.

11. The PVC method of claim 10, wherein the transform prediction block is used in the intra-frame prediction, and a result of deblocking filtering the transform prediction block is used in the inter-frame prediction.

12. A PVC method using visual perception characteristics, the method comprising:
generating a residual signal between an input block included in at least one frame and prediction data generated from inter-frame prediction or intra-frame prediction;
calculating a pixel domain JND if the input block is in a transform skip mode (TSM), and calculating a transform domain JND if the input block is in a non-transform skip mode (nonTSM);
if the input block is in the TSM, generating a shifted residual signal by performing transformshift on the residual signal, and shifting the calculated pixel domain JND based on a size of the input block; and
performing quantization to the input block based on a value obtained by subtracting the shifted pixel domain JND from the shifted residual signal, if the input block is in the TSM, and subtracting the shifted transform domain JND from an output-transformed transform coefficient of the residual signal, if the input block is in the nonTSM.

13. A non-transitory computer-readable storage medium storing instructions thereon, the instructions when executed by a processor causing the processor to:
generate a residual signal between an input block included in at least one frame and prediction data generated from inter-frame prediction or intra-frame prediction;
calculate a transform domain just-noticeable difference (JND) for the input block;
shift the calculated transform domain JND based on a size of the input block; and
perform quantization to the input block based on a value obtained by subtracting the shifted transform domain JND from a transform coefficient of the residual signal.
